(19) United States
(12) Patent Application Publication
(10) Pub. No.: US 2023/0262845 A1
(43) Pub. Date: Aug. 17, 2023

(54) VARIABLE FREQUENCY DRIVE FOR FLASH JOULE HEATING SYSTEM AND METHOD

(71) Applicants: Universal Matter Inc., Burlington (CA); William Marsh Rice University, Houston, TX (US)

(72) Inventors: James Mitchell Tour, Bellaire, TX (US); Duy X Luong, Houston, TX (US); Carter Kittrell, Houston, TX (US); Tyler Cooksey, Houston, TX (US); Zhiyong Zhang, Houston, TX (US); Vladimir Mancevski, Austin, TX (US)

(21) Appl. No.: 18/109,457

(22) Filed: Feb. 14, 2023

Related U.S. Application Data
(60) Provisional application No. 63/309,897, filed on Feb. 14, 2022.

(51) Int. Cl. H05B 3/00; H05B 1/02

(52) U.S. Cl. CPC H05B 3/0023; H05B 1/02; H05B 2203/035

(57) ABSTRACT

Systems and methods for flash joule heating carbon with variable frequency drives, for the production of graphene. The system includes a flash joule heating system, and a variable frequency drive system for driving the flash joule heating system, wherein the variable frequency drive system is coupled to the flash joule heating system, and is configured to output a pulse-width modulated current. The system and methods may further include sample temperature feedback, to adjust the output of variable frequency drive system.

### TECHNICAL FIELD

The following relates generally to flash joule heating systems and methods, and more particularly to systems and methods for flash joule heating with variable frequency drives, with temperature control.

### INTRODUCTION

This disclosure builds on a flash joule heating synthesis method and compositions thereof described in Patent Cooperation Treaty Application having International Publication Number WO 2020/051000 A1 to Tour et al., having an international publication date of Mar. 12, 2020, which is incorporated herein by reference in its entirety.

### SUMMARY

Provided are systems and methods for flash joule heating with variable frequency drives, with temperature control, for the production of graphene.

According to an embodiment, disclosed is a system for the production of graphene. The system includes a flash joule heating system, and a variable frequency drive system for driving the flash joule heating system, wherein the variable frequency drive system is coupled to the flash joule heating system.

According to some embodiments, the variable frequency drive system comprises a pulse width modulated output.

According to some embodiments, the variable frequency drive system comprises an insulated gate bipolar transistor for switching an output of the variable frequency drive system.

According to some embodiments, the system comprises a variable frequency controller for varying an output of the variable frequency drive system.

According to some embodiments, the flash joule heating system heats a sample to a maximum temperature of 3000° C.

According to some embodiments, the variable frequency drive system outputs a pulse width modulated current with a frequency between 100 Hz and 10000 Hz

According to some embodiments, an output of the variable frequency drive system is adjusted according to a feedback signal of a temperature of a sample.

According to some embodiments, the feedback signal comprises a temperature measurement of a sample comprising the mean value of multiple temperature sensors.

According to some embodiments, the output of the variable frequency drive system is adjusted according to a proportional integral derivative control scheme.

According to some embodiments, the proportional integral derivative control scheme is a dynamic proportional integral derivative control scheme, wherein the proportional integral derivative parameters are varied according to the feedback signal.

Disclosed is a method for the production of graphene, according to an embodiment. The method includes providing a carbon sample, and applying flash joule heating to the carbon sample to produce graphene, wherein the flash joule heating step is driven by a variable frequency drive system.

According to some embodiments, the variable frequency drive system comprises a pulse width modulated output.

According to some embodiments, the sample is heated to 3000° C.

According to some embodiments, the variable frequency drive system is driven by a variable frequency drive controller.

According to some embodiments, the controller comprises a temperature sensor coupled to the sample, and the controller applies a closed loop control scheme to vary the output of the variable frequency drive system.

According to some embodiments, the controller applies a proportional integral derivative control scheme.

According to some embodiments, the controller applies a dynamic proportional integral derivative control scheme, wherein the proportional integral derivative parameters are varied according to a feedback signal.

According to some embodiments, the temperature sensor comprises multiple temperature sensors, wherein the outputs of each individual temperature sensor are averaged to determine a mean temperature.

According to some embodiments, the heating step first comprises a variable frequency drive system duty cycle of 10%, followed by a variable frequency drive system duty cycle adjusted according to the feedback signal.

Aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a system block diagram of a flash Joule heating system coupled to a variable frequency drive system, according to an embodiment;

FIG. 2 is schematic of a flash Joule heating system with IGBTs used for pulse width modulation (PWM) switching, according to an embodiment;

FIG. 3A is a graph depicting the current and temperature of a VFD flashing system over time, according to an embodiment;

FIG. 3B is a graph depicting the temperature of a VFD flashing system over time, according to an embodiment;

FIG. 4A is a graph of the temperature over time of a VFD flash Joule heating system, according to an embodiment;

FIG. 4B is a graph of the duty cycle over time of a VFD flash Joule heating system, according to an embodiment;

FIG. 5A is a graph of a production rate of a flash joule heating system, a photograph of a flashing system, and a photograph of an automated flashing system, according to an embodiment;

FIG. 5B is a photograph of a flashing system, according to an embodiment;

FIG. 5C is a photograph of an automated flashing system, according to an embodiment; and

FIG. 6 is a flow chart depicting a method of producing graphene by driving a flash joule heating system with a variable frequency drive, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

A description of an embodiment with several components in communication with each other does not imply that all such components are required. On the contrary, a variety of optional components are described to illustrate the wide variety of possible embodiments of the present disclosure.

Further, although process steps, method steps, algorithms or the like may be described (in the disclosure and / or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device / article (whether or not they cooperate) may be used in place of a single device / article. Similarly, where more than one device or article is described herein (whether or not they cooperate), it will be readily apparent that a single device / article may be used in place of the more than one device or article.

The following relates generally to flash joule heating systems and methods, and more particularly to systems and methods for flash joule heating with variable frequency drives, with temperature control, for the production of graphene from carbon samples.

The systems and methods described herein apply a variable frequency drive system (VFD) to deliver the voltage across a carbon sample subjected to flash joule heating. Flash joule heating this carbon sample may produce graphene of varying forms. The process of inverting DC voltage to variable voltage variable frequency AC voltage in an inverter section of a VFD may be referred to as pulse width modulation (PWM). Pulse-width modulation is a widely used means of controlling power, for example, for provision to large induction motors. PMW provides a generally regular, (e.g. in some examples, sinusoidal) current output, to control frequency and voltage. PWM VFDs are efficient and typically provide high levels of performance. VFDs described herein may utilize insulated gate bipolar transistors or IGBTs for the generation of their variable frequency drive output.

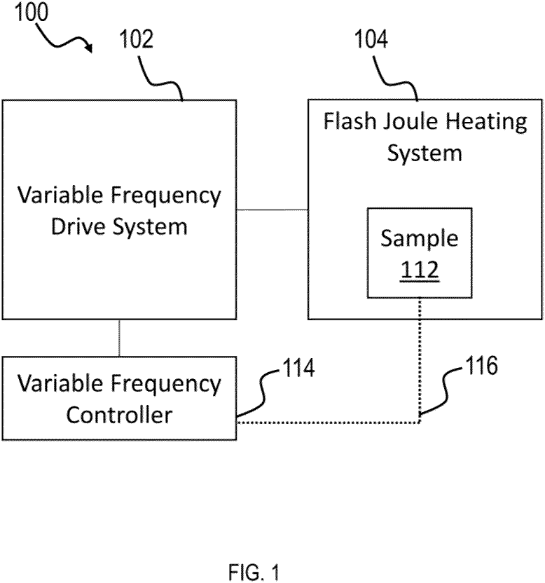

Referring first to FIG. 1, pictured therein is a block diagram 100 of a variable frequency drive system 102 coupled to a flash joule heating system 104, for driving the flash joule heating system 104. As described in International Publication Number WO 2020/051000 A1, the application of a flash joule heating system 104 for the production of graphene may provide for graphene with specific favorable properties. The flash joule heating system 104 may be driven by a supply of electrical current. Supplies of electrical currents with differing characteristics (e.g. time variation, or current) may result in differing graphene production characteristics.

Flash joule heating system 104 comprises an electrical system, configured to be driven by an electrical current source, for heating a carbon containing sample (e.g. sample 112). In some examples, sample 112 may be conductive, and may be substantially non-graphene carbon. Flash joule heating system 104 heats the sample 112 using resistive electric heating, wherein a current is discharged through the sample 112, heating the sample 112. The heating characteristics of system 104 may vary according to the character of the current discharged through sample 112.

Variable frequency drive system 102 comprises an electrical system for delivering electrical current with a particular character, magnitude, and time variation to flash joule heating system 104. For example, variable frequency drive system 102 may provide a pulse width modulated output current, with a certain peak current, frequency, duty cycle and other characteristics.

Coupled to variable frequency drive system 102 is controller 114. Controller 114 may send control signals to system 102 to adjust the output of system 102. For example, controller 114 may provide a periodic control signal, which the output of system 102 may be matched to. Such a periodic control signal may comprise a sinusoidal control signal, a square wave signal, or any other signal known in the art. Such periodic control signals may vary over time. For example, the period of the signal may continuously increase or decrease.

Controller 114 may comprise a computing device, microcontroller, single board computer, programmable logic controller, signal generator, PID controller or any other controller type known in the art which may supply a control signal to drive system 102 to adjust and/or modulate the output of heating system 104, to optimize graphene production from initial sample 112. Controller 114 may be coupled, directly or indirectly, to switching components of system 104, such as transistors, relays, or other controllable switches.

In some examples, controller 114 may be coupled to sample 112, to receive temperature feedback 116. Temperature feedback 116 may allow controller 114 to modulate the output of system 102, to alter the heating rate or conditions of heating system 104. Temperature feedback 116 may comprise a thermocouple, infrared pyrometer, emission spectroscopy or other spectroscopy-based temperature measurement, or any other thermal measurement method or mechanism suitable for measuring temperatures up to 3000° C. in some embodiments. In some examples, feedback 116 may comprise the average value of multiple temperature measurements from multiple sensors. In such examples, this average value may more accurately correspond to the average temperature of sample 112, due to uneven heat distribution across the sample.

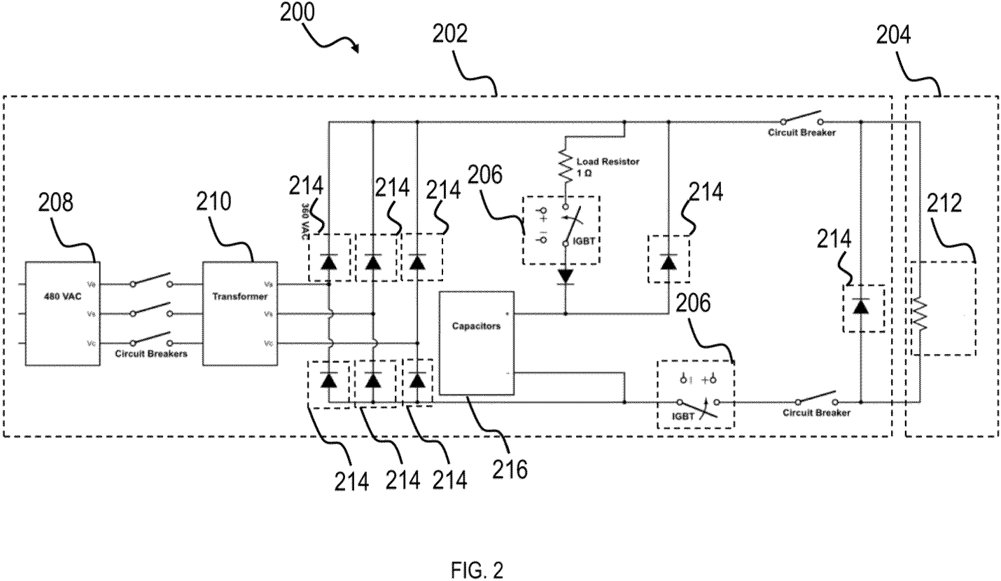

Referring now to FIG. 2, shown therein is an electrical schematic 200 of a variable frequency drive system 202 coupled to a flash Joule heating system 204, according to an embodiment. Drive system 202 may correspond to system 102 and system 204 may correspond to system 104. Variable frequency drive 202 is driven by a 480 VAC input source, converted to 360 VAC through the application of a transformer 210. The 360 VAC current is then rectified using a plurality of diodes 214, and capacitor 216. The output of system 204 comprises a pulse width modulated output, with IGBTs (e.g. IGBTS 206) used for pulse width modulation (PWM) switching. It may be advantageous to use Insulated Gate Bipolar Transistors (IGBTs) for the high current, high frequency switching, as other solid-state relays and/or switching components may not provide the speed as well as current rating for the operation of the flash joule heating system 204 for the production of graphene.

In other embodiments, other configurations or circuit designs may be present within the variable frequency drive system. For example, such a system may include a single or a plurality of integrated circuits, according to some embodiments.

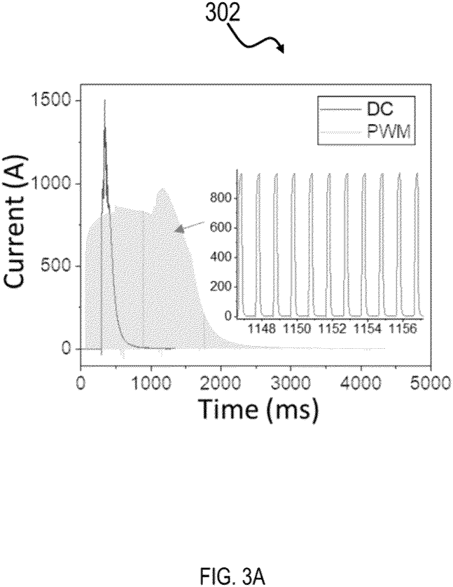

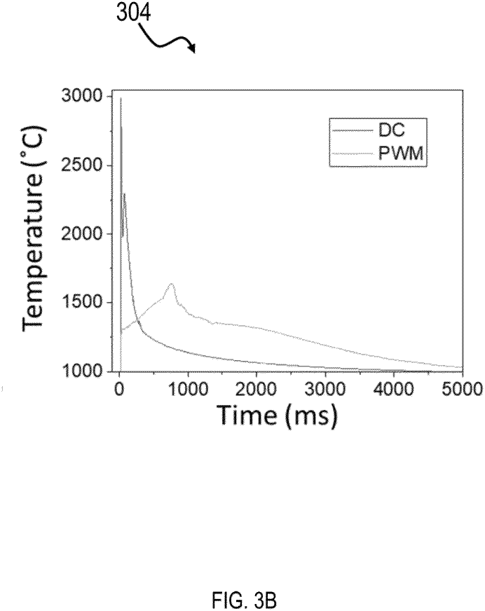

Referring now to FIG. 3, FIG. 3A comprises graph 302 and FIG. 3B comprises graph 304. At graph 302, shown therein is the current profile of DC flash vs PWM flash for joule heating-based production of graphene. The pulse sequence of the PWM flash is shown in the inset. At graph 304 of FIG. 3, pictured therein is a temperature profile of the same DC and PWM flash.

In some examples wherein DC flash methods are applied, pretreatment (e.g. the application of lower current or voltage flashes) is needed to avoid violent outgassing from the sample that could result in the explosion of the sample. After a few pretreatments of lower voltage and current, the typical, full power DC flash may be applied, with a peak current of more than 1500 A. In contrast, VFD system-based methods, lower voltage pretreatment is not necessary, and the peak current output during the flashing process may be less than 1000 A, reducing the flashing time and the risk of explosion and equipment failure, while increasing the energy efficiency and production throughput.

As seen in 304, temperature profile shows the DC flash has higher temperature with 3000° C. peak and <500 ms flash duration. The PWM flash method peaks at 1600° C. but has a longer duration of ~2 s. However, when comparing the graphene quality produced by each respective method using Raman spectroscopy, the two graphene samples are similar spectroscopically. This result indicates that the lower temperature of the VFD method may be compensated by longer flashing time. Even though the DC flash seems to have shorter duration, the production throughput using DC is much lower than with a PWM flash due to the addition of pretreatment flashes needed in the DC method.

In some examples, a VFD frequency may preferably be in the range of 100-10000 Hz with a duty cycle range of 0-50% to optimize graphene production. The VFD flash may employ a soft start, wherein a low duty cycle output is first provided to slowly heat the sample to remove some of volatile compounds from within the sample.

In some examples, the systems and methods described herein may apply a temperature control system using Proportional, Integral, Derivative (PID) control schemes, state space control schemes, or any other closed loop control scheme known in the art.

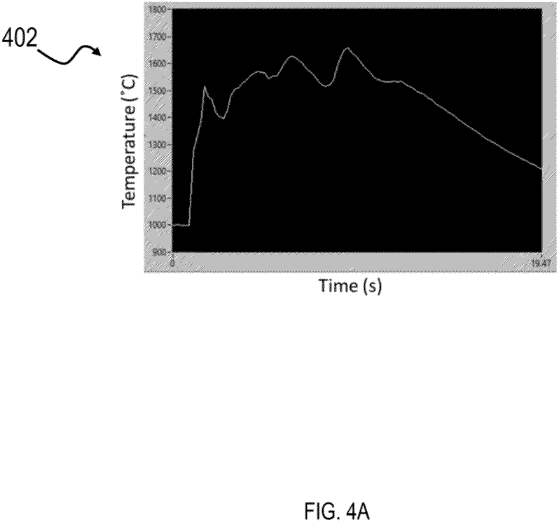

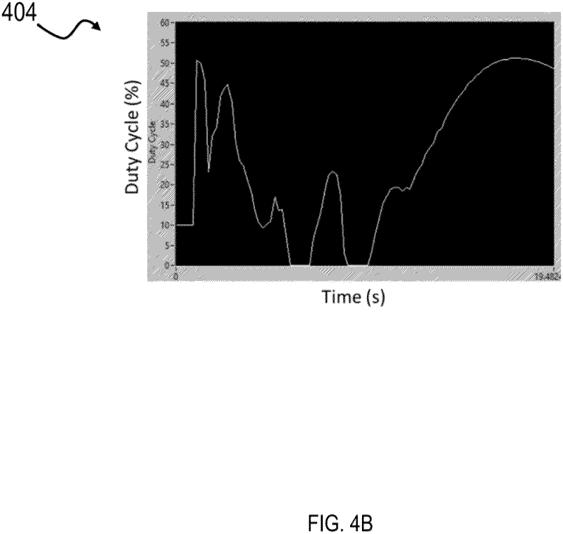

Referring now to FIG. 4, shown therein is graph 402 in FIG. 4A and graph 404 in FIG. 4B, each showing temperature control of a flash joule heating process, with dynamic PID. Graph 402 shows temperature profile of the flash joule heating process with a 1600° C. target temperature PID controlled. Graph 404 shows duty cycle that changes, corresponding to the measured temperature fluctuation (e.g. using feedback such as feedback 116), to maintain the target temperature.

In some examples, the VFD system allows for high-speed temperature control with dynamic PID. In such examples, the PID parameters change with the temperature and the voltage of a capacitor, modifying the characteristics of the current output of the VFD system. For example, PID parameters may vary to produce a soft start, heating the sample at low temperature and subsequently, provide for an aggressive flash of current toward the end of the flash joule heating process to compensate for falling voltage.

In the example of FIG. 4, the duty cycle of the flash joule heating process is initialized at 10% for a soft start. When the temperature increases and fluctuates, the duty cycle changes accordingly to maintain the target temperature, according to a temperature feedback signal (e.g. feedback 116). Toward the end of the flash joule heating process, the duty cycle is increased to compensate for the falling temperature and voltage. The duty cycle may be continuously adjusted according to temperature and/or capacitor voltage feedback.

The systems and methods described herein may comprise temperature readings which are not representative of the average temperature of the sample. Such measurements may be adjusted or calibrated to account for this discrepancy. In some examples, multiple IR pyrometers may be employed to collect multiple measurements, to determine an average measured temperature, which may more closely correspond to an overall average temperature.

The systems and methods described herein may be employed for any other flash heating process and/or configuration that includes the production of other 2D materials, and/or material phase changes.

The systems and methods described herein may be applied to perform lab scale synthesis of materials such as flash joule heating sourced graphene.

The systems and methods described herein may be used to heat a carbon sample to a maximum temperature of 3000° C., according to some embodiments.

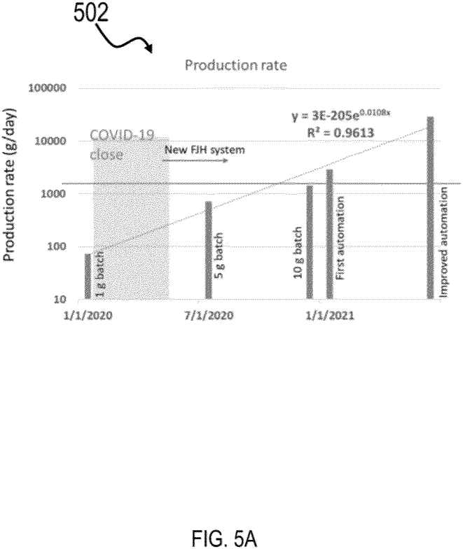

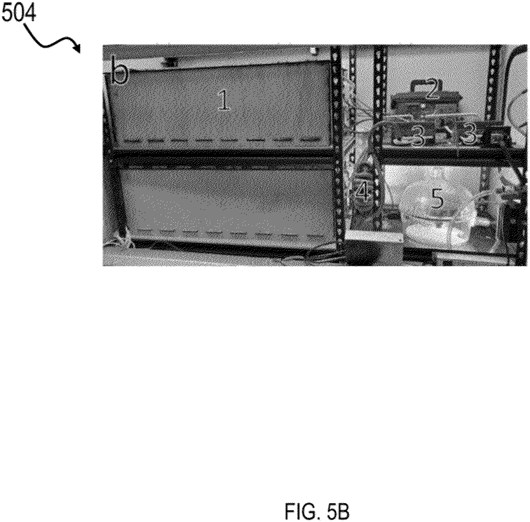

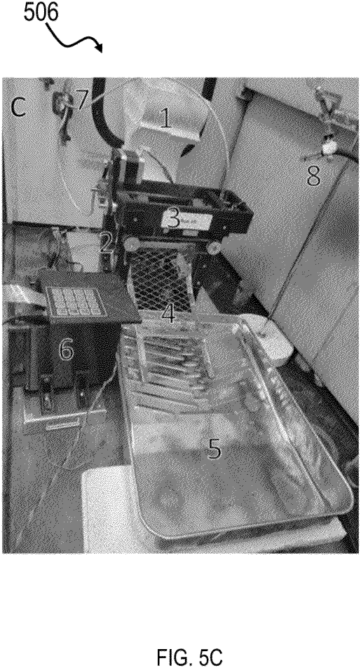

Referring now to FIG. 5, FIG. 5A comprises graph 502, FIG. 5B comprises photograph 504 and FIG. 5C comprises photograph 506.

Shown at graph 502 is the production rate using a flash Joule heating process.

Shown at photograph 504 is an example of a scaled-up flashing system for the production of graphene. The system comprises a total capacitance of 0.624 F with a 500 VDC rating, and is capable of flashing 10 g of metallurgy coke per batch. In photograph 504, “1” corresponds to 6 capacitor banks, each has 8 capacitors with 13 mF and 500 V capacitance, “B2” corresponds to a switching controller (e.g. analogous to variable frequency controller 114), “B3” corresponds to kill switches, “B4” corresponds to an inductor with a 1 mH inductance and “B5” corresponds to the flashing chamber.

Shown at photograph 506 is an example of an automated system capable of flashing 5.7 g batch of metallurgy coke per batch and reloading the new sample with ~20 s cycling. The system of photograph 506 may correspond to system 100 and/or the system of FIG. 2. “C1” corresponds to a sample hoop that can hold 50 samples, “C2” corresponds to an automation frame, “C3” corresponds to a flashing jig, “C4” corresponds to a sample ramp, “C5” corresponds to a sample tray, “C6” corresponds to an automation controller, “C7” corresponds to a connector to the flashing system, and “C8” corresponds to a compressed air nozzle.

From the discovery publication of the flash Joule heating process, graphene production rate has doubled each 9 weeks on average (Gram-scale bottom-up flash graphene synthesis. Nature, 577(7792), pp.647-651, Luong, D.X., Bets, K.V., Algozeeb, W.A., Stanford, M.G., Kittrell, C., Chen, W., Salvatierra, R.V., Ren, M., McHugh, E.A., Advincula, P.A. and Wang, Z., 2020.). This exponential growth in production rate is driven by two additions: a higher capacity flashing system which capable of flashing 10 g of metallurgy coke each batch and an automated sample reloading system.

The flashing system may be powered by 48 capacitors at total of 0.624 F capacitance. Each 8 capacitors may be assembled into a capacitor bank and controlled by a solid-state relay. 6 capacitor banks may be coupled to a kill switch before wiring the banks to the sample jig. To slow down the current for more stable electrical control, a 1 mH inductor is put in series with the circuit. The carbon sample may then be flashed in the controlled environment flashing chamber or in ambient atmosphere, producing graphene.

The automated system pictured in photograph 506 is controlled by a customized LabVIEW program. Once the sample is loaded inside the flashing jig, the flashing system will commence the flash. After the flash is done, the sample is dropped into a collecting tray and the new sample will be loaded into the flashing jig.

The high rate of automation is possible as the VFD-based flash heating method allows for fast cycling time with a single flash without the need for pre-flashing, as described above in reference to DC-based flashing methods.

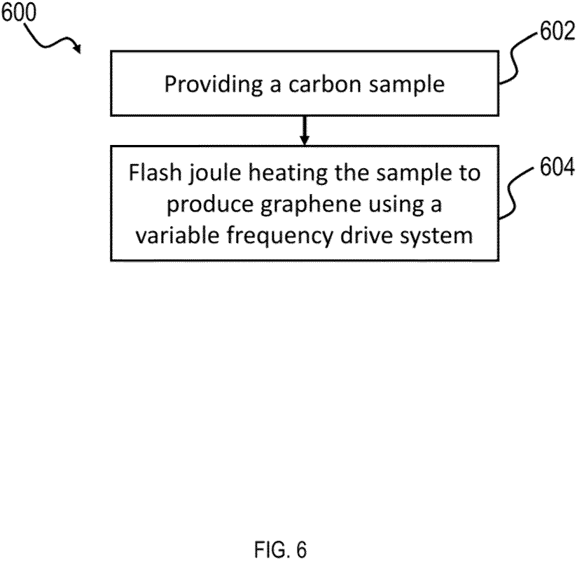

Referring now to FIG. 6, shown therein is a flow chart detailing a method 600 of producing graphene. Method 600 comprises steps 602 and 604.

At step 602, a sample is provided for conversion to graphene. The sample may comprise graphite or other forms of carbon.

At step 604, the sample is flash joule heated to produce graphene, the flash joule heating driven using a variable frequency drive system.

In some examples of method 600, the variable frequency drive system provides a pulse width modulated output. In some examples of method 600, the variable frequency drive system is driven by a variable frequency controller.

The variable frequency drive system of method 600 may correspond to system 102 or 202 in some embodiments. The flash joule heating system of method 600 may correspond to system 104 or 204 in some embodiments.

While the above description provides examples of one or more apparatus, methods, or systems, it will be appreciated that other apparatus, methods, or systems may be within the scope of the claims as interpreted by one of skill in the art.

1. A system for the production of graphene, the system comprising:
a flash joule heating system; and
a variable frequency drive system for driving the flash joule heating system;
wherein the variable frequency drive system is coupled to the flash joule heating system.

2. The system of claim 1, wherein the variable frequency drive system comprises a pulse width modulated output.

3. The system of claim 1, wherein the variable frequency drive system comprises an insulated gate bipolar transistor for switching an output of the variable frequency drive system.

4. The system of claim 1, wherein the system comprises a variable frequency controller for varying an output of the variable frequency drive system.

5. The system of claim 1, wherein the flash joule heating system heats a sample to a maximum temperature of 3000° C.

6. The system of claim 1, wherein the variable frequency drive system outputs a pulse width modulated current with a frequency between 100 Hz and 10000 Hz.

7. The system of claim 1, wherein an output of the variable frequency drive system is adjusted according to a feedback signal of a temperature of a sample.

8. The system of claim 7, wherein the feedback signal comprises a temperature measurement of a sample comprising the mean value of the output of multiple temperature sensors.

9. The system of claim 7, wherein the output of the variable frequency drive system is adjusted according to a proportional integral derivative control scheme.

10. The system of claim 9, where the proportional integral derivative control scheme is a dynamic proportional integral derivative control scheme, wherein the proportional integral derivative parameters are varied according to the feedback signal.

11. A method for the production of graphene, the method comprising:
providing a carbon sample; and
applying flash joule heating to the carbon sample to produce graphene;
wherein the flash joule heating step is driven by a variable frequency drive system.

12. The method of claim 11, wherein the variable frequency drive system comprises a pulse width modulated output.

13. The method of claim 11, wherein the sample is heated to a maximum temperature of 3000° C.

14. The method of claim 11, wherein the variable frequency drive system is driven by a variable frequency drive controller.

15. The method of claim 14, wherein the controller comprises a temperature sensor coupled to the sample, and the controller applies a closed loop control scheme to vary the output of the variable frequency drive system according to feedback from the temperature sensor.

16. The method of claim 15, wherein the controller applies a proportional integral derivative control scheme.

17. The method of claim 15, wherein the controller applies a dynamic proportional integral derivative control scheme, wherein the proportional integral derivative parameters are varied according to the feedback.

18. The method of claim 15, wherein the temperature sensor comprises multiple temperature sensors, wherein the outputs of each individual temperature sensor are averaged to determine a mean temperature.

19. The method of claim 15, wherein the heating step first comprises a variable frequency drive system duty cycle of 10%, followed by a variable frequency drive system duty cycle adjusted according to the feedback.
